(19) United States
(12) Patent Application Publication
(10) Pub. No.: US 2008/0085824 A1
(43) Pub. Date: Apr. 10, 2008

(54) DEVICE FOR FOLDING AND BOLDING PLASTIC-LAMINATED PRE-CUT BLANKS

(75) Inventors: Dieter Sprandel, Esslingen (DE); Hans Lassnig, Esslingen (DE); Markus Hoffmann, Groembach (DE); Werner Wattinger, Chambesy/Geneva (CH)

Correspondence Address: Vern Maine & Associates, 100 MAIN STREET, P O BOX 3445, NASHUA, NH, 03061-3445, US

(73) Assignees: FORTUNA SPEZIALMASCHINEN GMBH, Weil der Stadt (DE); INTERNATIONAL PAPER BOX MACHINE COMPANY, Chambesy/Geneva (CH)

(21) Appl. No.: 11/863,361

(22) Filed: Sep. 28, 2007

(30) Foreign Application Priority Data
Oct. 4, 2006 (DE) 10 2006 048 278.6

(51) Int. Cl. B31B 1/26; F23D 14/46

(52) U.S. Cl. 493/399; 431/350

(57) ABSTRACT

The invention discloses a device for folding and bonding plastic-laminated pre-cut blanks, in particular PE-laminated cardboard packages for beverages, comprising a peeling station for selectively peeling off a plastic lamination of a pre-cut blank; a creasing station for production of a folding line in a blank; a heating station for selectively heating up a plastic lamination on a blank that is to be bonded; a folding station for folding a blank about a folding line; a pressing station for pressing and bonding a folded blank; and conveying means for conveying blanks through the stations. The heating station comprises a burner having an oblong burner chamber which is provided on its top with a series of flame openings arranged one behind the other in the axial direction, for permitting flames to exit the chamber, and a liquid cooling system.

### RELATED APPLICATIONS

This application claims Convention priority of German patent application serial no. 10 2006 048 278.2 filed on Oct. 4, 2006, the contents of which is fully incorporated by reference herewith.

### BACKGROUND OF THE INVENTION

The present invention relates to a device for folding and bonding plastic-laminated pre-cut blanks, in particular PE-laminated cardboard packages for beverages.

Beverage packages used for milk-based and fruit-based beverages are produced from plastic-laminated pre-cut blanks, in particular from blanks coated with polyethylene (PE).

For producing a closed package from such a blank, the blank has to be folded several times and to be closed by bonding. Further, the lateral surface that is to be bonded to the opposite surface must be subjected to a process known as pre-folding to guarantee food grade for the package. In carrying out the pre-folding step, the plastic lamination is at first peeled off and is then bonded to an adjacent part of the blank by application of pressure, after having been folded about a folding line previously produced. Bonding is effected by the plastic lamination that has been heated up locally to a sufficient degree.

Devices for folding and bonding plastic-laminated pre-cut blanks, known in the prior art, therefore comprise the following stations:
a peeling station for selectively peeling off the plastic lamination of a pre-cut blank;
   a creasing station for production of a folding line in a blank;
   a heating station for selectively heating up a plastic lamination on a blank that is to be bonded;
   a folding station for folding a blank about a folding line;
   a pressing station for pressing and bonding a folded blank; and
   conveying means for conveying blanks through the stations.

The heating station must meet quite a number of demands. Flat blanks, that are fed through the heating station at high speed, must be heated up locally in the area of the bond to be produced, to a degree sufficient to ensure that the plastic-lamination will be adequately plasticized so as to establish a safe bond with the opposite edge of the blank in the subsequent pressing station. As the throughput speeds of such systems are very high, in the range of up to approximately 1000 m/min., short-time local heating-up of the blanks is not easy to realize.

Systems using hot air for that purpose have become known by public use in the prior art.

However, such systems are complex, and it is difficult for such systems to guarantee adequate selective heating-up of the blank at very high throughput speeds.

One may imagine to use a burner for direct heating of the blank, which would allow a clearly higher heat output to be achieved provided the blanks can be heated up by the flames directly, but it would be a problem of that solution that an oblong burner, over which the blanks would have to travel, may easily lead to local overheating and that the burner as such may be distorted by the heat so that the required precision would no longer be guaranteed.

### SUMMARY OF THE INVENTION

In view of this, it is a first object of the invention to disclose an improved device for folding and bonding plastic-laminated pre-cut blanks, in particular PE-laminated cardboard packages for beverages.

It is a second object of the invention to disclose an improved device for folding and bonding plastic-laminated pre-cut blanks wherein the heating station allows a plastic lamination on a pre-cut blank to be bonded to be selectively heated at high precision.

It is a third object of the invention to disclose an improved device for folding and bonding plastic-laminated pre-cut blanks which allows for a fast heating-up speed and a high throughput speed.

According to the present invention, these and other objects are achieved by a device for folding and bonding plastic-laminated pre-cut blanks, in particular PE-laminated cardboard packages for beverages, comprising:
a peeling station for selectively peeling off a plastic lamination of a pre-cut blank;
a creasing station for production of a folding line in a blank;
a heating station for selectively heating up a plastic lamination on a blank that is to be bonded;
a folding station for folding a blank about a folding line;
a pressing station for pressing and bonding a folded blank; and
conveying means for conveying blanks through the stations;
wherein the heating station comprises a burner having an oblong burner chamber which is provided on its top with a series of flame openings arranged one behind the other in the axial direction, for permitting the flames to exit the chamber, and a liquid cooling system.

The object of the invention is fully achieved in this way.

The use of a burner having an oblong burner chamber, which is provided on its top with a series of flame openings arranged one behind the other in the axial direction, for permitting the flames to exit the chamber, allows blanks traveling at high speed over the flames in longitudinal direction to be heated up directly and selectively. Local overheating and distortion of the burner can largely be excluded due to the liquid cooling system used in the burner. This permits precise adjustment of the burner relative to the blanks traveling over the burner at high speed, whereby direct selective heating-up of the blanks is facilitated and can be precisely controlled.

According to an advantageous further development of the invention, the burner comprises flame control surfaces extending on both sides of the flame openings.

This guarantees that the flames will be directly guided to a blank passing above the flames, and improves the burning behavior of the burner.

According to a further embodiment of the invention the burner chamber has a tubular shape and is provided with heat sinks arranged on both sides of the flame openings, which are passed by a cooling liquid.

This provides a simple and solid burner structure, with the heat sinks arranged on both sides guaranteeing intensive cooling of the burner so that any influences, that would impair the blank in the areas that should not be heated, are prevented and at the same time distortion of the burner is largely excluded.

According to a further embodiment of the invention, each of the heat sinks comprises an inlet opening at a first axial end and a discharge opening for cooling liquid at a second axial end.

One thereby achieves a simple structure for the heat sinks, combined with high cooling efficiency.

According to a further embodiment of the invention, each of the heat sinks comprises a hollow space that is connected with the burner chamber by screwing.

By connecting the heat sink with the burner chamber by screwing, highly efficient contact can be obtained between the heat sink and the burner wall, which in turn improves the cooling efficiency.

According to a further embodiment of the invention, the heat sinks are passed in axial direction by a series of bushes that extend between an inner wall of the heat sink, which faces the burner chamber, and an opposite outer wall of the heat sink, and that are sealed off relative to the hollow space.

Such an embodiment makes it possible to connect the heat sinks with the burner chamber by screws extending through the bushes.

It is possible in this way to ensure highly effective contact between the heat sinks and the outer wall of the burner chamber, over the full length thereof. If necessary, the heat flow can be further improved by application of a heat transfer compound between the heat sink and the outer wall of the burner chamber.

Preferably, a gas, in particular a natural gas, a propane or butane gas, or any other suitable gas mixture, is used for operation of the burner.

This allows the burner to be given a simple structure and prevents contamination of the blanks by liquid fuel.

According to a further embodiment of the invention, adjusting means are provided for adjusting the position of the burner relative to the conveyor means.

This permits the burner to be exactly positioned relative to the blanks traveling over the burner so that selective heating-up of the blanks can be achieved even at high throughput speeds.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will become apparent from the description that follows of a preferred embodiment of the invention, with reference to the drawing. In the drawings:

FIG. 1 shows a diagrammatic representation of a device according to the invention for folding and bonding plastic-laminated pre-cut blanks;

FIG. 2 shows a perspective view of a burner station according to the invention, with one burner;

FIG. 3 shows a perspective view of a heat sink according to FIG. 2, in reduced scale;

FIG. 4 shows a cross-section of the burner, with a heat sink screwed to the burner, in enlarged scale;

FIG. 5 shows a cross-section of a modification of the burner illustrated in FIG. 4;

FIG. 6 shows a cross-section of another modification of the burner illustrated in FIG. 4.

### DETAILED DESCRIPTION OF THE PREFERRED EMBODIMENTS

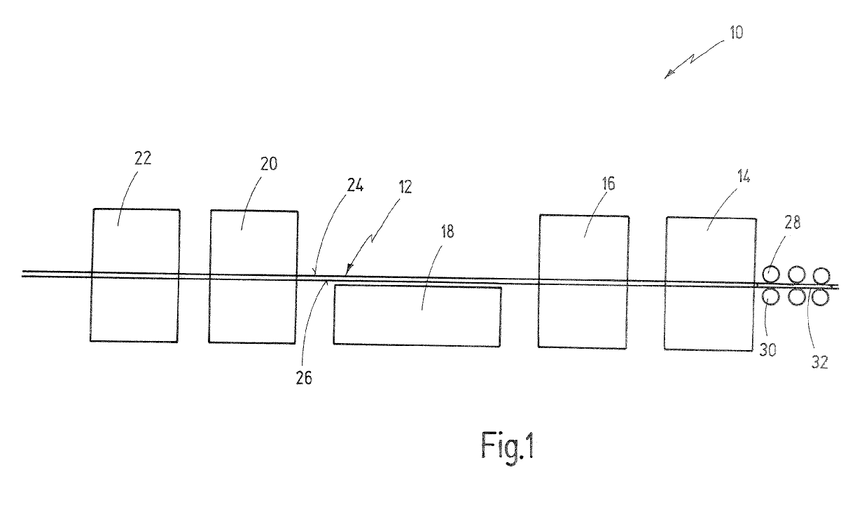

A device according to the invention for folding and bonding plastic-laminated pre-cut blanks is illustrated diagrammatically in FIG. 1, and is indicated generally by reference numeral 10.

The pre-cut blanks 32 are PE-laminated cardboard blanks from which beverage packages are to be produced by folding and bonding. The side of the blanks which later forms the inside of the package to be produced is fully covered by a thin laminated polyethylene coating. The blanks 32 are transported through the different stations 14, 16, 18, 20, 22 of the device 10 by conveyor means 12 at a high throughput speed of several hundred meters per minute up to approximately 1000 meters per minute. The conveyor means 12 comprises belts 24, 26 that are driven by rollers 28, 30 for moving the blanks 32 between them. In FIG. 1 only a few rollers 28 are indicated diagrammatically above an upper conveyor belt 24, and a few rollers 30 are indicated diagrammatically below a lower conveyor belt 26, at the inlet of the device 10 only. It is, however, understood that the two conveyor belts extend through the entire device at a suitable spacing and in parallel one to the other, being guided by suitable rollers from above and from below.

A first station 14, designed as peeling station, initially serves to peel the blanks 32 in the area of a lateral edge in order to peel off the plastic-lamination in selected areas. This can be done in a manner known as such using a bell-type knife.

The blanks 32 then travel from the peeling station 14 to a creasing station 16 where one or more creases are formed that will be used as folding lines later. This can be done for example using suitable rollers provided with a suitable projection on their outer circumference on the one hand and an associated backup roller with a corresponding recess on the other hand.

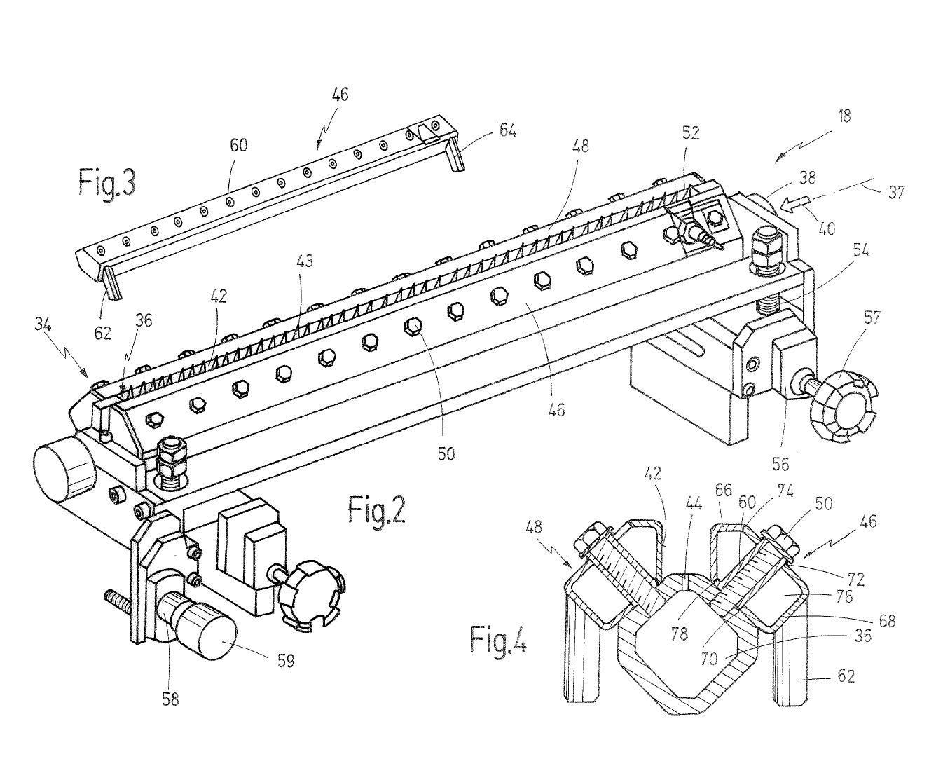

Following the creasing station 16, the blanks 32 are then conveyed to a heating station 18 where the blanks are selectively heated along an outer edge, in the area where the bond is to be produced later, until the plastic lamination has been heated up sufficiently to guarantee successful subsequent bonding by application of pressure. The heating station 18 will be described hereafter in more detail with reference to FIGS. 2 to 6.

Having left the heating station 18, the blanks 32 then enter a folding station 20 where the blanks 32 are folded once or several times about corresponding folding lines.

Folding can be effected for example by causing the blanks, i.e. the area of the folding line, to pass between oppositely arranged rollers that are gradually offset one from the other by small angles over the length of the folding station so that, finally, the roller pair located at the end of the folding station is offset from the roller pair at the beginning of the folding station by approximately 90°, whereby folding by 90° is effected.

Having left the folding station 20, the blanks 32 finally reach the pressing station 22 where a marginal plastic lamination, having been adequately heated up in the heating station 18, and the opposite edge of the folded blank are connected one with the other by bonding and pressing.

This can be effected for example by passing the blanks through suitable roller pairs.

The structure of the heating station will now be described in more detail with reference to FIGS. 2 to 6. The heating station 18 comprises a burner, indicated generally by reference numeral 34, configured as a gas burner. The burner 34 comprises an oblong tubular burner chamber 36 (compare FIG. 4) having a square cross-section with flattened corners and being provided with a connecting pipe 38 at its first axial end. A series of flame openings 24, arranged one behind the other in the axial direction 37, are provided on the upper surface of the burner chamber 36 for permitting flames to issue in operation of the burner 34 for directly heating a blank 32 that passes over the burner.

The burner 34 is provided, on both sides of each of the flame openings 34, with a heat sink 46, 48 that extends over the full length of the burner chamber 36 and that has a flat surface, facing the burner, in contact with the flat outer surface of the respective wall of the burner chamber 36.

The heat sinks 46, 48 are designed as hollow bodies, having a connection pipe 62, 64 (compare FIG. 3) provided on each of their axial ends as inlet and outlet, respectively, for cooling liquid (as a rule water). The heat sinks 46, 48 are screwed to the wall of the burner chamber 36 by a series of screws 50 that are passed through bushes 60. In order to provide a connection between the heat sinks 46, 48 and the wall of the burner chamber 36 that is tight to liquids, each of the bushes 60 extends between that surface of a heat sink 46, 48 that faces the burner chamber 36 and the opposite outer surface of the heat sink, being welded to the respective wall in a manner that is tight to liquids (compare welding seams 70, 72 in FIG. 4). The heat sinks as such are composed from two angle sections 66, 68 which are welded together by welding seams 74, 78 that are tight to liquids.

As can be seen more clearly in FIG. 4, the flame openings 44 are enclosed on both sides by the adjacent inner surfaces 42 of the respective heat sinks 46, 48. Accordingly, the surfaces 42 have the function of flame control surfaces. This ensures that the flames issue from the flame openings 44 directly to the top, thereby improving the burning behavior.

As indicated by arrow 40, a burning gas mixture (for example a natural gas/air mixture) is introduced into the connection pipe 38. Ignition of the gas mixture so supplied can be achieved by a spark plug 52 arranged at the beginning of the burner 34.

In operation, blanks 32 carried between the conveyor belts 24, 26 of the conveying means 12 are transported laterally of and in parallel to the burner so that the portion of the blank 32 that is to be heated up moves in axial direction 37, above the flames 43 issuing from the upper end of the burner 34.

In order to guarantee correct positioning of the burner 34 relative to a blank 32 traveling above the burner, the burner 34 can be located in vertical direction using adjusting means 54, and can be adjusted and set, respectively, by set wheels 57, 59 of adjusting means 56, 58.

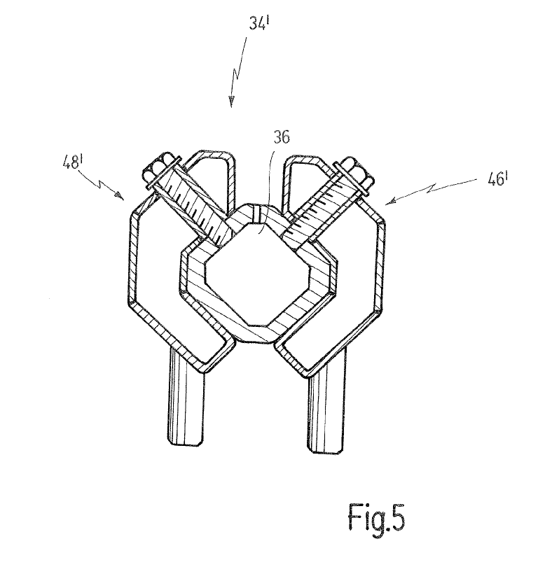

While FIG. 4 shows a first embodiment of the burner 34, with heat sinks 46, 48 in contact with the two lateral surfaces of the burner chamber wall, a second embodiment of the burner, indicated generally by reference numeral 34′, is shown in FIG. 5.

The burner chamber 36 of that embodiment is identical to the embodiment of FIG. 4. The burner 34′ differs from the burner 34 illustrated in FIG. 4 only by a modified design of the heat sinks 46′, 48′. The latter extend not only around the flat lateral surfaces on both sides of the flame openings 44, but are additionally extended in downward direction so that a cooling contact is additionally established with the flattened corners of the burning chamber 36 that follow the flat lateral surfaces. This clearly increases the cross-sectional area of the heat sinks 46′, 48′, compared with the embodiment according to FIGS. 1 to 4, so that the cooling efficiency is improved still further.

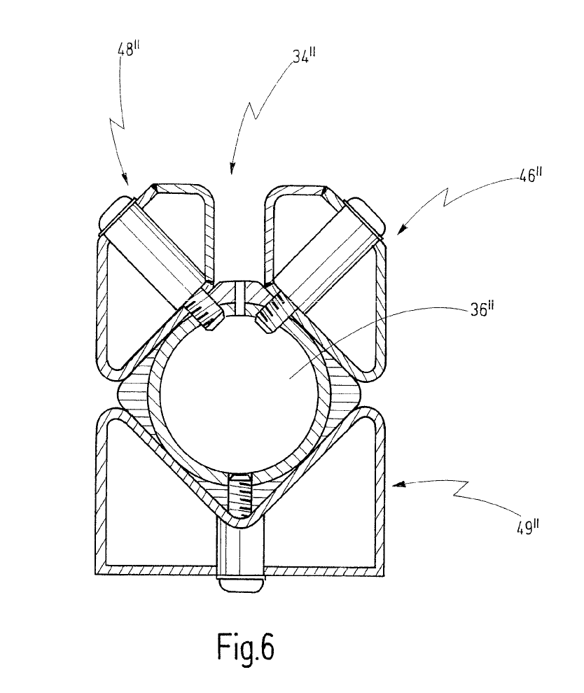

A further embodiment of the burner according to the invention is shown in FIG. 6 and designated in total with 34″.

The burner chamber 36 herein has a cylindrical inner surface. A total of three heat sinks 46″, 46″ and 49″ are provided around the burner chamber 36. A simple manufacture with less welding seams results therefrom.

What is claimed is:

1. A device for folding and bonding plastic-laminated pre-cut blanks, comprising:
a peeling station for selectively peeling off a plastic lamination of a pre-cut blank;
a creasing station for producing a folding line on a blank;
a heating station for selectively heating up a plastic lamination provided on a blank that is to be bonded;
a folding station for folding a blank about a folding line;
a pressing station for pressing and bonding a folded blank; and
a conveyor for conveying blanks through said stations;
wherein said heating station comprises a burner, said burner comprising:
an oblong burner chamber having a tubular shape;
a series of flame openings provided on a top of said burner and being arranged one behind the other in an axial direction of said burner chamber, said flame openings permitting flames to exit from said burner chamber;
flame control surfaces extending on both sides of said flame openings; and
hollow heat sinks arranged on both sides of said flame openings having inflow and outflow openings for passing a cooling liquid therethrough.

2. A device for folding and bonding plastic-laminated pre-cut blanks, comprising:
a peeling station for selectively peeling off a plastic lamination of a pre-cut blank;
a creasing station for producing a folding line on a blank;
a heating station for selectively heating up a plastic lamination provided on a blank that is to be bonded;
a folding station for folding a blank about a folding line;
a pressing station for pressing and bonding a folded blank; and
a conveyor for conveying blanks through said stations;
wherein said heating station comprises a burner, said burner comprising:
an oblong burner chamber;
a series of flame opening provided on a top of said burner, said flame openings permitting flames to exit from said burner chamber; and
a liquid cooling system for cooling said burner.

3. The device of claim 2, wherein said flame openings are arranged one behind the other in an axial direction of said burner chamber.

4. The device of claim 2, wherein said burner further comprises flame control surfaces extending on both sides of said flame openings.

5. The device of claim 2, wherein said burner chamber has a tubular shape.

6. The device of claim 2, wherein said burner further comprises heat sinks arranged on both sides of said flame openings and which are configured for liquid cooling.

7. The device of claim 6, wherein each of said heat sinks comprises an inlet opening at a first axial end and a discharge opening for discharging cooling liquid at a second axial end.

8. The device of claim 7, wherein each of said heat sinks comprises a sealed hollow space that is screw-connected with said burner chamber.

9. The device of claim 8, wherein each of said heat sinks is passed by a series of bushes that extend between an inner wall of said heat sink and an opposite outer wall of said heat sink, and that are sealed against said hollow space.

10. The device as defined in claim 9, wherein said heat sinks are connected with the burner chamber by screws extending through said bushes.

11. The device of claim 2, wherein said burner is configured as a gas burner.

12. The device of claim 2, further comprising adjusting means for adjusting the position of said burner relative to said conveyor.

13. The device of claim 1, wherein each of said heat sinks comprises a hollow space that is screw-connected with said burner chamber.

14. The device of claim 13, wherein each of said heat sinks is passed by a series of bushes that extend between an inner wall of said heat sink and an opposite outer wall of said heat sink, and that are sealed against said hollow space.

15. The device of claim 14, wherein said heat sinks are connected with the burner chamber by screws extending through said bushes.

16. The device of claim 1, further comprising adjusting means for adjusting the position of said burner relative to said conveyor.

17. A gas burner for directly heating plastic-laminated pre-cut blanks for softening a laminate coating provided thereon, said gas burner comprising:
an oblong burner chamber;
a series of flame openings provided on a top of said burner, said flame openings being arranged one behind the other in an axial direction of said burner chamber and permitting flames to exit from said burner chamber; and
hollow heat sinks for cooling said burner chamber being arranged on both sides of said flame openings having inflow and outflow openings for passing a cooling liquid therethrough.

18. The gas burner of claim 17, wherein said burner further comprises flame control surfaces extending on both sides of said flame openings.

19. The gas burner of claim 17, wherein said burner chamber has a tubular shape.

20. The device of claim 17, wherein each of said heat sinks comprises an inlet opening at a first axial end and a discharge opening for discharging cooling liquid at a second axial end.
